(19) United States
(12) Patent Application Publication
(10) Pub. No.: US 2003/0140112 A1
(43) Pub. Date: Jul. 24, 2003

(54) ELECTRONIC MESSAGING SYSTEM METHOD AND APPARATUS

(76) Inventors: SATISH RAMACHANDRAN, Los Altos, CA (US); Bradley Arthur Taylor, Menlo Park, CA (US)

Correspondence Address: DAVID E. LOVEJOY, REG. NO. 22,748, 102 REED RANCH ROAD, TIBURON, CA, 94920-2025, US

(21) Appl. No.: 09/434,048

(22) Filed: Nov. 4, 1999

(51) Int. Cl. G06F 15/16

(52) U.S. Cl. 709/217

(57) ABSTRACT

A message system for communication of messages over a network where the messages include meta data and content data. An authentication unit authenticates users for messages from the network and a storage server unit that stores the messages. The storage server unit includes a plurality of protocol server units for processing the messages according to protocols used for the messages over the network, includes a meta-data storage unit for storing the meta data of messages, includes a content-data storage unit for string the content data of messages, and includes a manager unit for common control of the meta-data storage unit and the content-data storage unit. The manager unit includes a common addressing unit for common management of the addresses of messages at locations in the storage server unit for messages of the plurality of protocol server units and a common access control unit for controlling accesses to the locations in the storage server unit by the plurality of protocol server units.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates to the field of electronic messaging systems and particularly to messaging systems capable of using different internet protocols.

In early email messaging systems, mail messages were typically delivered to a single time-sharing machine within an organization and each User would login to that machine to read the User's email. Today, email Users often have one or more machines at work, a personal computer at home, and a portable computer so that a distributed messaging architecture that accommodates different modes of operation is required. There are three general modes of operation in a distributed messaging system, namely, offline, online and disconnected. When a client/server architecture is employed, the client is, for example, a workstation or personal computer.

In offline operation, messages are delivered over a network to a shared server and a User periodically connects to the server and downloads all of the pending messages to the client machine. A client mail fetches messages from the server to the client machine where the mail program is running and the messages are deleted from the server. Thereafter, message processing is local on the client machine.

In online operation, messages are left on the mail server and manipulated remotely by mail client programs—possibly more than one at a time, and probably more than one at different times.

In disconnected operation, a mail client connects to the mail server, makes a “cache” copy of selected messages, and then disconnects from the server, later to reconnect and resynchronize with the server. The User may then operate on the message cache offline, but this model differs from the offline model in that the primary copy of messages remains on the server, and the mail client program will subsequently re-connect to the server and re-synchronize message status between the server and the client's message cache. Online and disconnected operation complement each other and one may alternate between them; however, neither is compatible with offline operation since, by definition, offline operation implies deleting the messages from the server after they've been copied to the client machine's local disk.

Any one of several client-server protocols can be used to access remote message stores, including general purpose file access protocols and application-specific protocols. Whenever mail is delivered to one machine but read on a different one, there is a need for a network protocol to access the messages on the server machine. A determination must be made as to which protocol is to be used to access message data when using different machines. The question applies both to incoming message folders (for example a User's INBOX) and also to saved-message folders. When reading incoming message folders, a common operation is to save a message to an archive folder, so both data sets must be available simultaneously. The selected protocol can be a generic remote file system access protocol (for example, NFS, SMB), an application-specific message access protocol, for example, Post Office Protocol (POP) and Internet Message Access Protocol (IMAP).

A generic remote file system protocol is generally not the choice for email accessing of remote message stores because there is no single file system universally available for all computers, installation and operation can be difficult, and inefficient use of network bandwidth often results.

Application-specific protocols are the usual choice for email accessing of remote message stores since such protocols can be tailored to maximize performance, can provide a logical split for processing between client and server to minimize data transmitted across the network, can be installed without special privileges, and can insulate the client program from the file format used on the server. Although proprietary/vendor-specific solution programs and the X.400 P7 message access protocol are available, the internet message access protocols (POP, DMSP, and IMAP) and specifically, POP and IMAP, are the only ones widely accepted.

The Post Office Protocol (POP) dates from 1984 and has gone through several revisions and the current one is POP3. POP was designed specifically to support offline access; but with limitations has also been applied to the other two paradigms. The Distributed Mail System Protocol (DMSP) was first defined in 1986 and has since been revised. Unlike POP, DMSP has not been widely supported and is largely limited to a single application, PCMAIL. DMSP was designed specifically to accommodate the disconnected operation support in PCMAIL.

The Internet Message Access Protocol (IMAP) was originated in 1986 and has been revised with IMAP4 being the current version. IMAE P was originally designed to support the online access model. Since IMAP includes a functional superset of POP capabilities and can fully support offline access as well as POP does, and with additions made in version 4 it can also support disconnected operation. The latest version of IMAP therefore includes the functionality of both POP and DMSP.

Electronic messaging extends well beyond e-mail messages to any form of electronic messages including e-mail, fax, voice mail and groupware. Many of the needs and limitations of e-mail systems extend to other forms of electronic messages and there is a need for a coherent and integrated electronic messaging system that operates using different types of electronic messages.

In connection with message systems, it is desirable to use databases for storage of information. However, conventional databases are difficult to use in message system environments which need to be scalable to accommodate larger and larger numbers of messages in an efficient manner that does not degrade access speed.

In accordance with the above background, the present invention provides a coherent and integrated scalable electronic messaging system capable of operating efficiently with different Internet protocols and capable of operating with different forms of electronic messages.

### SUMMARY OF THE INVENTION

The present invention is a message system for communication of messages over a network where the messages include meta data and content data. An authentication unit authenticates users for messages from the network and a storage server unit stores the messages. The storage server unit includes a plurality of protocol server units for processing the messages according to protocols used for the messages over the network, includes a meta-data storage unit for storing the meta data of messages, includes a content-data storage unit for string the content data of messages, and includes a manager unit for common control of the meta-data storage unit and the content-data storage unit. The manager unit includes a common addressing unit for common management of the addresses of messages at locations in the storage server unit for messages of the plurality of protocol server units and a common access control unit for controlling accesses to the locations in the storage server unit by the plurality of protocol server units.

The foregoing and other objects, features and advantages of the invention will be apparent from the following detailed description in conjunction with the drawings.

### BRIEF DESCRIPTION OF THE DRAWINGS

FIG. 1 depicts an electronic messaging system.

FIG. 2 depicts further details of the messaging system of FIG. 1.

FIG. 3 depicts one embodiment of the storage server of FIG. 2.

FIG. 4 depicts another embodiment of the storage server of FIG. 2.

FIG. 5 depicts further details of the an electronic mail system of FIG. 1 and FIG. 2.

FIG. 6 depicts further details of Users in the electronic mail system of FIG. 1 and FIG. 2.

FIG. 7 depicts the common units of a server unit manage.

FIG. 8 depicts de tails of the service unit manager.

FIG. 9 depicts a representation of one mail message in the electronic mail system.

FIG. 10 depicts a representation of another mail message in the electronic mail system.

### DETAILED DESCRIPTION

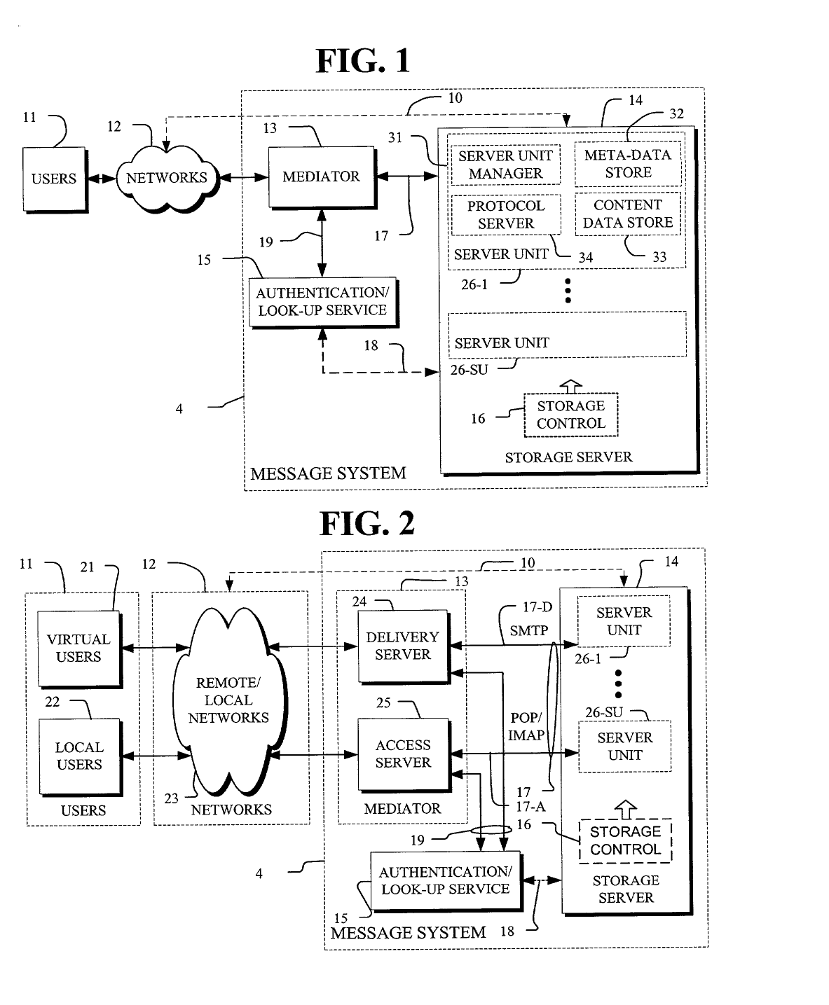

Electronic Messaging System—FIG. 1

FIG. 1 depicts an electronic messaging system that enable Users 11 to send and receive electronic messages to and from the electronic message system 4 and thereby to and from other Users. The Users 11 are any type of machine located at a person's place of work, at home, or at other fixed or portable locations. The Users 11 can operate under human control or independently of human control. Typically, the electronic messaging system has a client/server distributed messaging architecture that accommodates different modes of operation including offline (download and delete), online and disconnected modes. The messages to be sent and stored are any type of electronic message including e-mail, fax, voice and groupware.

The FIG. 1 electronic messaging system uses special purpose Internet protocols, including POP, IMAP and SMTP, or other protocols compatibility with Internet operations and communications over the networks 12. Both POP and IMAP protocols for User accessing of messages over the networks 12 rely on the SMTP protocol for sending messages over the networks 12. The Users 11 can be nomadic and are independent of any particular remote file protocol. Typically, the Users 11 can send, retrieve, and save messages over connections 17 and can manage remote User folders in storage server 14. The electronic messaging system operates to retrieve and update status information on a per-message basis. Users can retrieve and update personal configuration information and can share mailboxes. The electronic messaging system mail delivery for Users 11 is usually to a shared and “always available” storage server 14 that allows access to new messages from a variety of client platform types and allows access to new mail from anywhere over networks 12.

In FIG. 1, the electronic messages are partitioned into two parts, namely, a meta-data part and a content-data part. The meta-data part includes User, message, time, date, address and other identification information and the content-data part includes the content associated with the meta-data part. The content and meta-data are linked by pointers stored with the meta-data that point to the locations in the content-data store 33 where the associated content is stored.

In the FIG. 1 electronic messaging system, the Users 11 connect to networks 12 which in turn connect to a mediator 13 which in turn connects to storage server 14. An authentication/look up service 15 connects to mediator 13 over connections 19. Under certain options, the networks 12 bypass the mediator 13 and connect directly over connections 10 to the storage server 14 in which case the authentication/look up service 15 also connects to the storage server 14 over connections 18.

In FIG. 1, the mediator 13 is a transparent proxy that accepts logins from Users 11, authenticates them using the authentication/look-up service 15, and if successfully authenticated, transparently proxies User commands to the storage server 14 and proxies responses from the storage server 14 to the Users 11. The storage server 14 stores User mailboxes located in server units 26, including storage server units 26-1, . . . , 26-SU, where each server unit internally includes a message meta-data store 32, a message content-data store 33 and a server unit manager 31.

Each individual mailbox for a User is distributed across the meta-data store 32 and the message content-data store 33 and is accessed under control of the server unit manager 31. Each individual mailbox for a User is not distributed across different ones of the server units 26-1, . . . , 26-SU. Coordination of Users among the server units 26 is under control of the storage control 16.

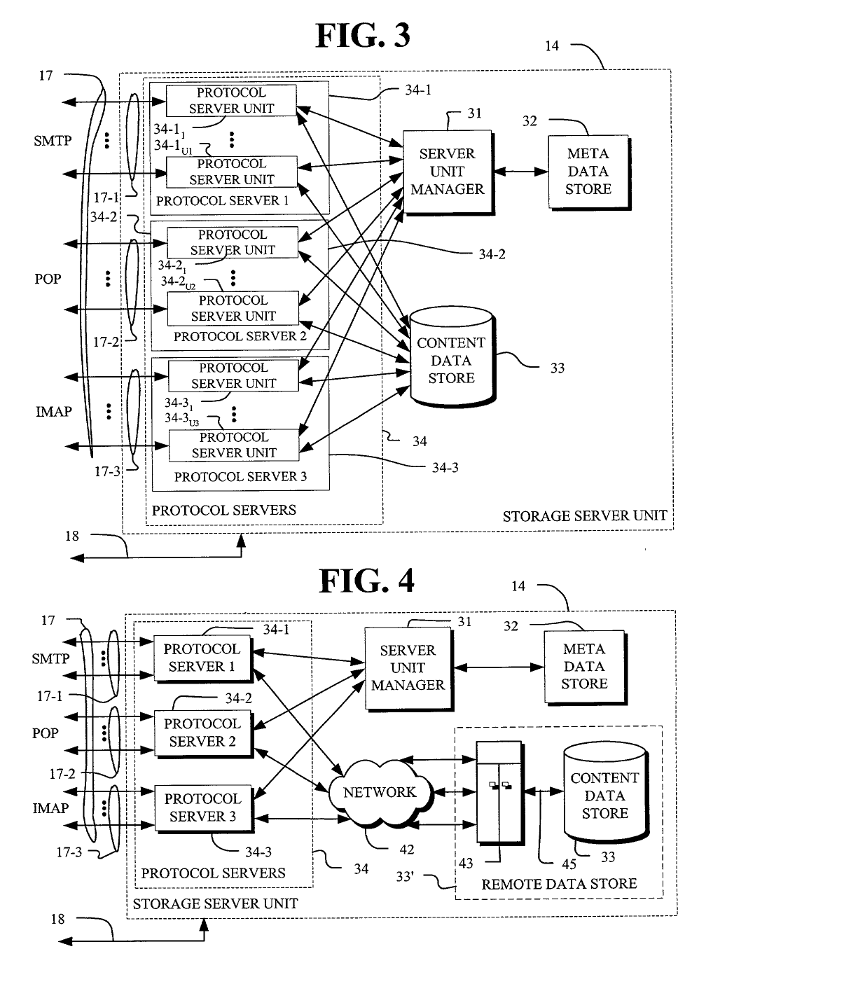

The server unit manager 31 in each server unit 26 manages the accessing of data in the message meta-data store 32 and the message content-data store 33 and services protocol commands that cause data to be retrieved or modified. The server unit manager 31 coordinates multiple requests to the same mailboxes. The server unit manager 31 is a process, thread or other computational entity that functions to manage the address space of the server unit 26 including the meta-data store 32. The address space is common for the protocol server 34 (including each of the protocol servers 34-1, 34-2 and 34-3, see FIG. 3) and does not require any locking protocol for locations accessed in the storage server unit 26. Further, each storage server unit 26 is efficient in that when tables of offsets or other mechanisms for accessing physical addresses are opened, they can remain open since the address space is under the common control of the server unit manager 31.

In the FIG. 1 electronic messaging system, Internet messages are sent using the Simple Mail Transfer Protocol (SMTP), both POP and I AP use SMTP to send messages. In a similar manner, accessing and updating personal configuration information is relegated to a separate companion protocol.

In the FIG. 1 electronic messaging system, disconnected operation has the same requirements as online operation while messages in a particular User folder are uniquely identifiable throughout the life of that folder so that clients and servers can periodically resynchronize the status of particular messages.

Electronic Messaging System Using POP IMAP And SMTP—FIG. 2

FIG. 2 depicts further details of the messaging system of FIG. 1 in which the message system 4 for communication with Internet protocols use the SMTP protocol for delivery over connections 17D and use POP and/or IMAP protocols for access over connections 17A. In FIG. 2, the Users 11 include virtual Users 21 (connected, for example over the Internet or other remote network) and local Users 22 (connected, for example, over a local area network) so that the networks 12 include remote and local networks 23. The mediator 13 includes a delivery server 24 (using the SMTP protocol) and an access server 25 (using an internet access protocol such as POP or IMAP). The storage server 14 includes storage server units 26-1, . . . , 26-SU and a storage control 16. The authentication/look up service 15 connects to both the access server 25 and the delivery server 24 over connections 19. In the case where the networks 12 bypass the mediator 13 over connections 10, the service 15 also connects to the storage server 14 over connections 18.

The storage server 14 of FIG. 2 stores User mailboxes located in server units 26, including units 26-1, . . . , 26-SU, where each server unit 26 internally includes a message meta-data store 32, a message content-data store 33 and a server unit manager 31 as described in connection with the storage server 14 of FIG. 1. Coordination among the server units 26-1, . . . , 26-SU is under control of the storage control 16. In each server unit 26, the server unit manager 31 manages the accessing of data in the message meta-data store 32 and the message content-data store 33.

Storage Server Unit with Local Content-Data Store—FIG. 3

FIG. 3 depicts an embodiment of a typical one of the storage server units 26 within the messaging systems of FIG. 1 and FIG. 2. In FIG. 3, the storage server unit 26 includes server unit manager 31, meta-data store 32 and content-data store 33. The inputs and outputs to and from the server unit manager 31 and content-data store 33 are from the protocol servers 34-1 (SMTP), 34-2 (POP) and 34-3 (IMAP). The protocol server 34-1 (SMTP) includes the protocol server units 34-1₁, . . . , 34-1_{U1} which have the SMTP connections 17-1; the protocol server 34-2 (POP) includes the protocol server units 34-2₁, . . . , 34-2_{U2} which have the POP connections 17-2; and the protocol server 34-3 (IMAP) includes the protocol server units 34-31, . . . , 34-3_{U3} which have the IMAP connections 17-3. The protocol servers 34-1, 34-2 and 34-3 have connections 18 to the authentication/look up service 15 of FIG. 1 and FIG. 2.

The server unit manager 31 in the server unit 26 manages the accessing of data in the message meta-data store 32 and the message content-data store 33 and services protocol commands from the protocol server units 34 that cause data to be retrieved or modified. Any command for accessing a User mailbox is first processed by server unit manager 31 which responsively accesses meta-data store 32. Meta-data store 32 stores pointers to corresponding linked locations in content-data store 33 where the content portion of a message is stored or retrieved. The server unit manager 31 coordinates multiple requests to the same mailboxes by different ones of the protocol server units 34. In this manner, the server unit manager 31 manages the address space of the storage server unit 26. The address space is common for all of the protocol servers 34-1, 34-2 and 34-3 and each of the protocol server units 34-1₁, . . . , 34-1_{U1}; the protocol server units 34-2₁, . . . , 34-2_{U2}; and the protocol server units 34-3₁, . . . , 34-3_{U3}.

Storage Server Unit with Remote Content-Data Store—FIG. 4

In FIG. 4, the storage server unit 26 includes the protocol servers 34-1, 34-2 and 34-3, the server unit manager 31, the meta-data store 32 and the content-data store 33 located as part of a remote data store 33′ that includes a remote server 43. The remote data store 33′ is connected via network 42 to interface units 34. The protocol between server 43 and data store 45 is, for example, NFS or any other file system protocol.

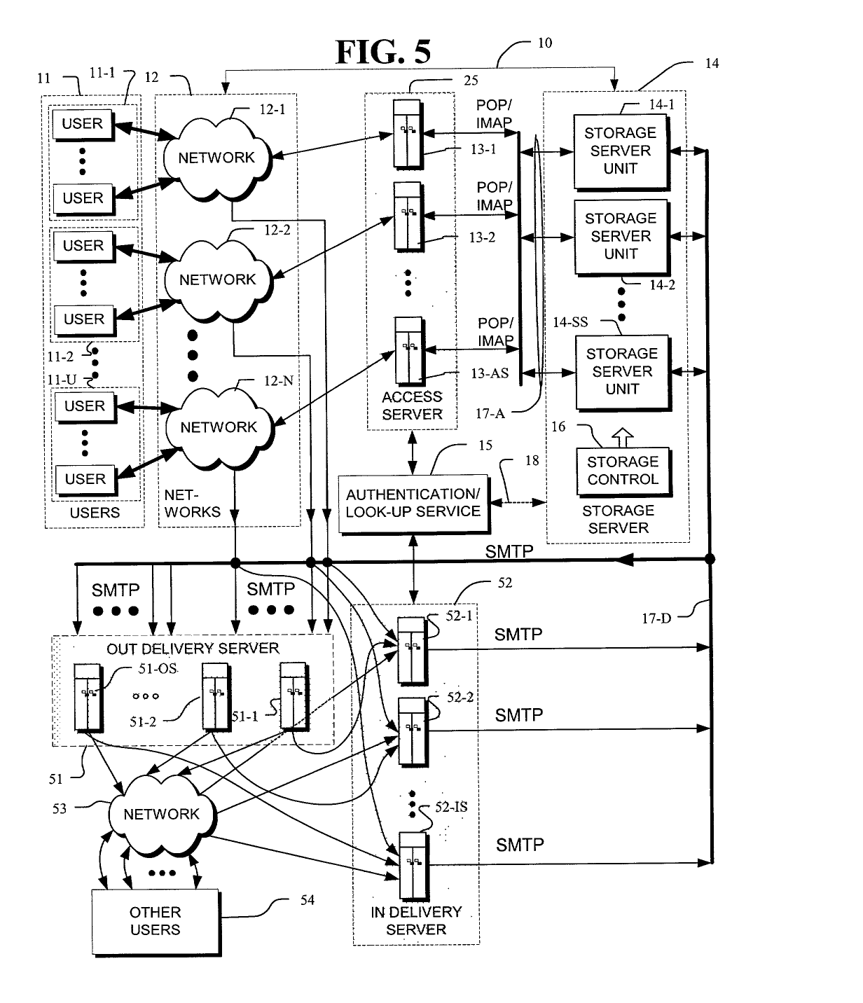

Electronic Messaging System Detail—FIG. 5

In FIG. 5, a plurality of Users 11 are organized in groups including the User groups 11-1, . . . , 11-U. The Users 11 connect to the network 12 including the networks 12-1, 12-2 . . . , 12-N. The network 12 in turn connects with POP/IMAP connections to the access server 13 and with SMTP connections to the out-delivery server 51 and the in-delivery server 52. The access server includes the access server units 13-1, 13-2, . . . , 13-S. The access server 13 connects with a POP/IMAP protocol to the storage server 14. The storage server 14 includes the storage server units 14-1, 14-2, . . . , 14-SS and the storage control 16. The out-delivery server 52 includes the out-delivery server units 51-1, 51-2, . . . , 51-OS and the in-delivery server 52 includes the in-delivery server units 52-1, 52-2, . . . , 52-IS.

In FIG. 5, the storage server units, 14-1, 14-2, . . . , 14-SS, provide SMTP connections to the out-delivery server 51 and to the in-delivery server 52. In FIG. 5, the out-delivery server 51 includes the out-delivery server units 51-1, 51-2, . . . , 51-OS. The out-delivery server units 51-1, 51-2, . . . , 51-OS connect as inputs to the network 53 and as inputs to the in-delivery server 52 and specifically the in-delivery server units 52-1, 52-2, . . . , 52-IS, respectively.

Communication into the out-delivery server 51 is via the SMTP protocol, including communications from the network 12, the storage server 14 and the in-delivery server 52.

In FIG. 5, the in-delivery server 52, including the server units 52-1, 52-2, . . . , 52-IS receive SMTP protocol inputs from the out-delivery server 51, the network 53, the network 12 and the storage server 14. The in-delivery server 52 delivers SMTP protocol communications to the storage server 14 and out-delivery server 51.

In FIG. 5, the network 53, which may include remote networks such as the Internet or local networks, connects to other Users 54.

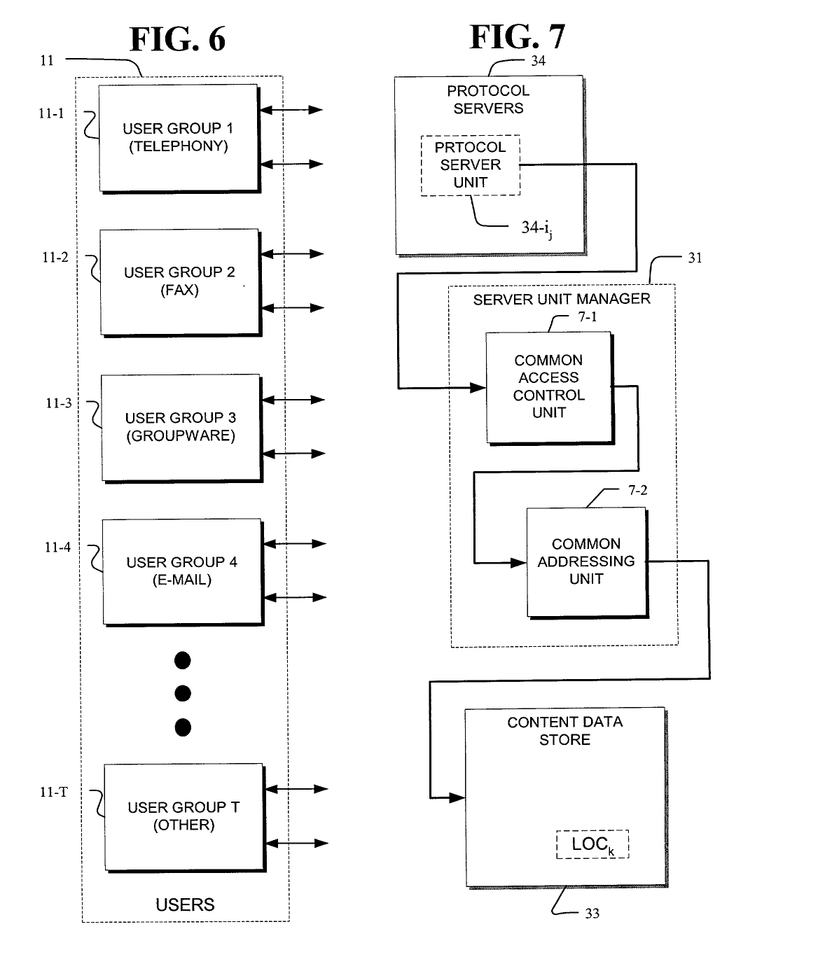

Multiple User Group Types—FIG. 6

FIG. 6 depicts an implementation of the Users 11 of FIG. 1, FIG. 2 and FIG. 5. In FIG. 6, the Users 11 are grouped by different User types, including the User group 11-1 which is of the telephony type. The User group 11-2 is of the facsimile type. The User group 11-3 is of the groupware type. The User group 11-4 is of the e-mail type. Any number of other group types can be included within the User categories and are generically designated as User group 11-T for designating other User types.

Server Unit Manager Common Units—FIG. 7.

In FIG. 7, the server unit manager 31 includes a common access control unit 7-1 and a common addressing unit 7-2. The common access control unit 7-1 receives messages from the protocol server units, where unit 34-iⱼ is typical of the protocol server 34, and has common processing for those messages. The accessing of mailbox locations, where location LOCₖ is typical, in the content data store 33 is under control to the common addressing unit 7-2. Since accessing of all mailboxes in the content data store 33 is under common control of server unit manager 31, errors by any one particular message server unit 34-iⱼ in the protocol server 34 tend not to disrupt the entire storage server unit 14.

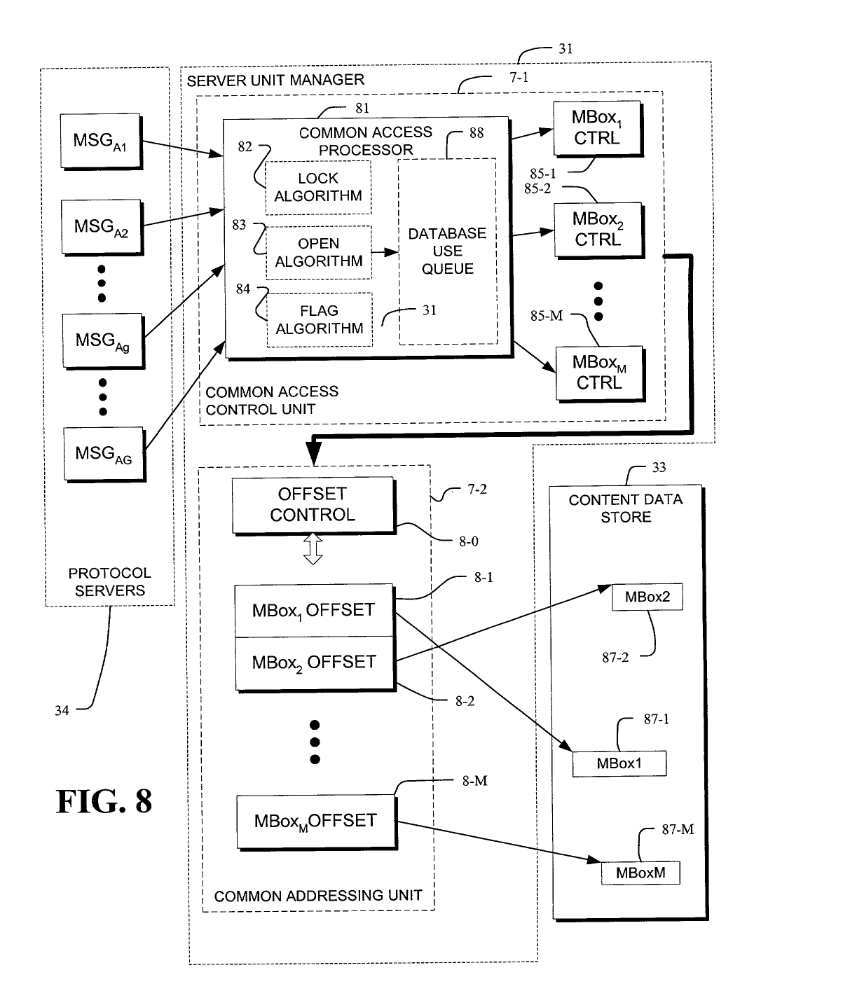

Server Unit Manager Details—FIG. 8.

In FIG. 8, further details of the service unit manager 31 are shown. The server unit manager 31 includes a common access processor 81 which processes the received messages from the protocol server 34 independent of the protocol server units from which they come. In particular, a group of messages from the protocol server 34 are designated MSG_{A1}, MSG_{A2}, . . . , MSG_{Am}, . . . , MSG_{AM}. Each of these messages is processed by processor 81 with the common algorithms which include, for example, a lock algorithm 82, an open algorithm 83 and a flag algorithm 84. The common access processor 81 by executing the common algorithms determines control states for different ones of the mailboxes 87 in the content data store 33 and specifically, mailboxes 87-1, 87-2, . . . , 87-M designated MBox₁, MBox₂, . . . , _{MboxM}, respectively. Specifically, the control states are stored in FIG. 8 in MBox₁CTRL, MBox₂CTRL, . . . , MBox_{M}CTRL designated as 85-1, 85-2, . . . , 85-M, respectively. The states are used by the common addressing unit 7-2 to control accessing of the mailboxes 87 in content data store 33. The common addressing unit 7-2 includes an off-set control 8-0 which functions to control calculation of offset addresses for mailbox locations in the content data store 33 of particular ones of the mailboxes used in connection with the messages MSG_{A1}, MSG_{A2}, . . . , MSG_{Am}, . . . , MSG_{AM} as a function of the control states 85-1, 85-2, . . . , 85-M.

In particular, the MSG_{A1} is processed by the common access control unit 7-1 to establish an offset address, for example, in the MBox₁ OFFSET 8-1. Similarly, MSG_{A2} has an offset address stored, for example, in the MBox_{M}OFFSET register 8-M and MSG_{AG} has an offset established, for example, in the MBox₂ designated 8-2. Under appropriate access conditions determined by the common access control unit 7-1, the messages MSG_{A1}, MSG_{A2} and MSG_{AG} access mailboxes MBox1, MBoxM and MBox2, respectively, in content data store 33. The server unit manager 31 operates to associate the messages from the protocol server 34 with the mailboxes 87 in content data store 33 using the file system of the content data store 33.

Locks. In conjunction with the file system, the common access processor 81 executes a lock algorithm 82 to determine if the addressed mailbox in the content data store 33 is available to be accessed. Assuming typical message MSG_{Ag} is to access mailbox MBox2, then the lock algorithm 82 obtains a lock and stores it in the MBox₂CTRL which locks the mailbox MBox2 for the duration of time that accessing by message MSG_{Ag} is required.

In FIG. 8, if at the time that MSG_{Ag} is accessing the mailbox MBox₂, another message MSG_{A1}, for example, also attempts to access mailbox MBox₂, then the lock algorithm 82 prevents the MSG_{A2} message from obtaining a lock and causes message MSG_{A2} to wait until the lock for MSG_{Ag} is removed.

In summary, the storage server 14 functions as follows:

SMTP delivers Received message MSGₘ to protocol server unit

Protocol server unit delivers Received message to server unit manager

Protocol server unit waits to obtain lock on addressed mailbox

When lock obtained, Protocol server adds new UID for Received message to UIDLIST

After Received message is delivered, protocol server unlocks addressed mailbox

Protocol server units issues return to SMTP message.

Common lock algorithm looks for any other termination and, if found, removes appropriate lock.

The lock algorithm 82 in the common access processor 81 functions to look for other terminations for all of the protocol servers and upon detection will automatically unlock the associated mailbox. Any termination of the protocol server of the message channel will cause the lock algorithm to sense the disruption and unlock the corresponding mailbox making it available to other messages. In this manner, failure of any particular protocol server unit 34-iⱼ will not hang the mailbox to which that unit was last connected. In this manner, the common processing by the lock algorithm 82 ensures a greater reliability of the overall system since individual protocol server units cannot hang mailboxes and make them inaccessable for long durations of time.

Operation of the lock and unlock operations are represented by the following sequence where an aborted connection causes a process crash:

Aborted Connection

POP: Acquire transaction ID (TXN) from manager

POP: Remove a UID from the MAILBOXDB UIDLIST (MAILBOXDB is thereby locked)

POP: Process crash

MGR: Detect lost connection

MGR: Aborts TXN, unlock database MAILBOXDB

Open. If the access connection to the content data store 33 for the addressed mailbox is not open, then the open algorithm 83 functions with the file system to open a connection to the addressed mailbox. The open algorithm 83 maintains the mailbox connection open for as long as access by the message is required. Additionally, for improved performance, the open algorithm 83 maintains connections open for longer periods of time. For example, the open algorithm 83 maintains the connection to the mailboxes open based on a most recently used criteria. The most recently used mailboxes are therefore quickly available for access by any new message, if the new message is to any one of the open mailboxes, without need to re-establish the connection using the file system. When new connections are required for mailboxes that are not open, then connections to the least recently used mailboxes are dropped to make room for the new connections.

The open algorithm 83 stores in the mailbox message queue 88 a list of open mailboxes. Whenever a new message, such as typical new message MSG_{Am} is processed by the common access processor 81, the open algorithm 83 pushes the new mailbox ID onto the top of the queue and consults the other entries on the queue 88 to determine if the mailbox for the new message MSG_{Am} is currently open. If open, a direct connection exists to the addressed mailbox in the content data store 33. If not open, then the open algorithm 83 obtains a connection. For each new mailbox added to the top of the queue, the other open mailboxes are pushed down in the queue. Whenever the queue 88 reaches a limit, a mailbox is purged from the queue 88 to make room for the new mailbox. Typically, the least recently used mailbox in the queue is purged to make room for a new mailbox. Closing of connections to mailboxes in content data store 33 is done independently of return messages from the protocol server 34. The use of purge algorithms that operate independently of return messages allows the system to operate more efficiently than if the protocol server both opened and closed connections on the receipt and return of messages.

An example of an open operation appears hereinafter in connection with the section III. IMAP, under the subsection “2. SELECT”.

Flags. Other conditions of access to the content data store are under control of the flag algorithm 84 which sets flags for various different conditions used to control and enhance access to the content data store by messages from the protocol server 34.

An example of a flag operation appears hereinafter in connection with section “III. IMAP”, under subsection “6. STORE”.

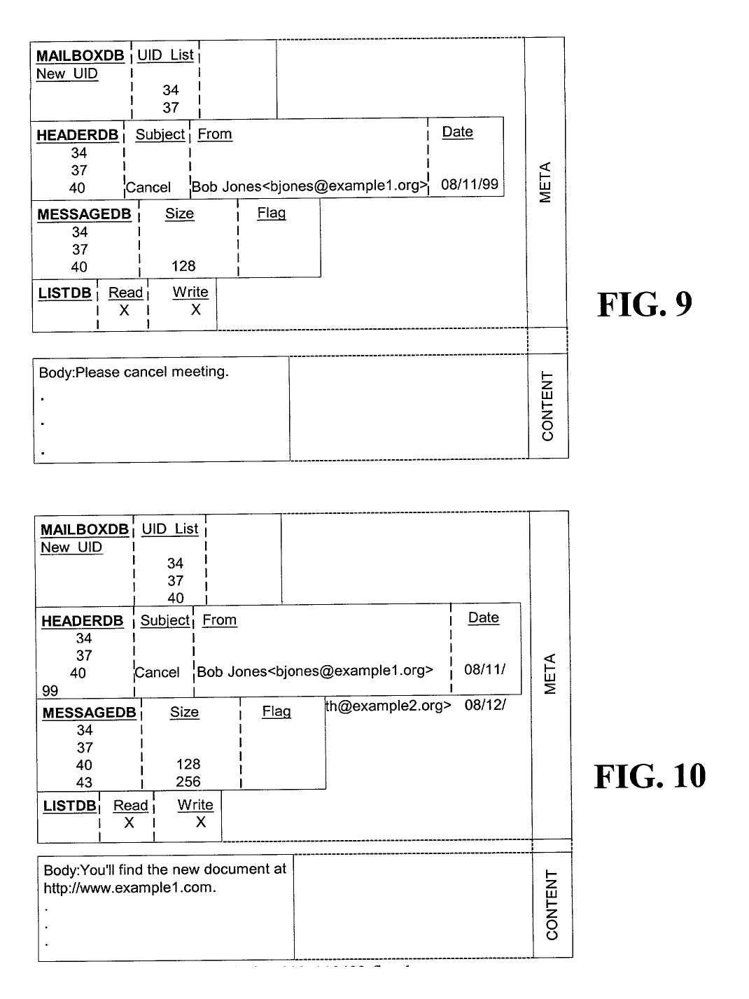

First Message—FIG. 9.

In FIG. 9, a typical one of the messages, such as MSG_{A1} in FIG. 8, is shown as message number 40 that is 128 bytes in size. The message of FIG. 9 is as follows:

To: Sara Brown <sara@example2.org>

From: Bob Jones <bjones@example1.org>

Subject: Cancel

Date: 08/11/99

Body: Please cancel meeting.

The message of FIG. 9 is stored as a with a New UID 40 where messages with UIDs 34 and 37 are currently in the MAILBOXDB database. The HEADERDB database for UID 40 stores the “Subject” field with Cancel, the from field with Bob Jones <bjones@example1.org> and the date field with 08/11/99. The MESSAGEDB stores the “Size” field with 128 and the “Flag” field is empty. The LISTDB marks the “Read” and “Write” fields as active indicating that the mailboxes are available for reading and writing. The body of the message is stored in the content data store at a location, for example, /usr/sara/40.

Second Message—FIG. 10.

In FIG. 10, a typical one of the messages, such as MSG_{A2} in FIG. 8 is shown as message number 43 that is 256 bytes in size. The message of FIG. 10 is as follows:

To:Sara Brown <sara(example2.org>

From:MarySmith <msmith@example1.org>

Subject:New

Date: 08/12/99

Body:You'll find the new document at http://www.example1.com.

The message of FIG. 10 is stored as a with a New UID 43 where messages with UIDs 34, 37 and 40 are currently in the MAILBOXDB database. The HEADERDB database for UID 43 stores the “Subject” field with New, the from field with Mary Smith <msmith@example2.org>and the date field with 08/12/99. The MESSAGEDB stores the “Size” field with 256 and the “Flag” field is empty. The LISTDB marks the “Read” and “Write” fields as active indicating that the mailboxes are available for reading and writing. The body of the message is stored in the content data store at a location, for example, /usr/sara/43.

Operation

POP Sessions. POP only serves one mailbox (the “inbox”). During the login session, User (for example, name=sbrown, passwd=funfun) will map to a unique mailbox (managed by and internal to the system). POP also does not allow for simultaneous read/write accesses to the same mailbox by multiple Users.

Login

User establishes connection to mediator 13.

User sends name, passwd to the mediator 13.

Mediator 13 authenticates the (name, passwd) pair against an Authentication/Look-Up Service 15.

If authentication failed, mediator 13 responds with an error as specified by the protocol and drops the connection (User must retry login from the beginning).

If authentication is successful, the mediator 13 and particularly the access server 25 accesses the particular one of the storage server units 14-1, . . . , 14-SS that hosts the User's specified mailbox. The accesses server 25 transparently establishes a connection (or reuses an existing connection) to the particular storage server unit 14. This connection lasts for the session duration.

User does a STAT (to determine the number of messages in mbox and their cumulative size)

Mediator 13 accepts the STAT command and relays to the host storage server unit 14.

Host storage server unit 14 does one of two things:

If the info is available in pre-computed form in the meta-data store 32, it retrieves it and sends it onward to mediator 13.

Else, the storage server unit 14 retrieves message meta-data info, on a per-message basis, from the meta-data store 32. It computes the response to STAT and responds to the mediator 13.—

Mediator 13 relays response to User.

User does a LIST command (to list all/specified message IDs and their respective sizes) to the mediator 13 which relays it to the host storage server unit 14. Storage server unit 14 looks up the number of messages and their sizes in the meta-data store 32 and passes the details to the mediator 13 which then passes it onto the User.

User does a RETR (to retrieve messages specified as argument to command)

Mediator 13 accepts RETR and relays it to the host storage server unit 14.

For each message specified in the argument, the host storage server unit:

First checks to see if the message is marked for deletion. If so, it returns an error to mediator 13.

Identifies the location where to retrieve the message content-data in content-data store 33. It retrieves content data for the message from the content-data store 33. This retrieval may happen over the local file system or over the network (for example, using NFS or SQL). It then sends the retrieval data to the mediator 13.

Mediator 13 relays the response to User.

User does a DELE (to delete the particular message specified as command argument).

Mediator 13 accepts and relays command+arg to the host storage server unit 14. For message specified in argument,

Storage Server Unit checks meta-data store 37 to see if message already marked for deletion. If so, returns error.

Else, it marks Deleted field for message in meta-data store 32.

User does a NOOP

Mediator 13 either responds to NOOP directly (i.e., without any additional traffic to/from a storage server unit 14) or relays command to storage server unit 14. Storage server unit 14 responds OK without any lookup.

User issues a RSET

Mediator 13 relays command to host storage server unit 14.

Storage server unit 14 looks up meta-data store and identifies messages marked for deletion.

If any found, it unmarks the Deleted field for each message marked for deletion. It then responds OK.

User issues QUIT

Mediator 13 relays command to host storage server unit 14.

Storage server unit 14 looks up messages marked for deletion in meta-data store 32.

It then removes each such message from the content-data store 33 as well as the corresponding entry in the meta-data store 32.

If problems are encountered in removing deleted messages, the storage server unit 14 returns an error. Else it returns an OK.

Mediator 13 relays response.

User issues UIDL

Mediator 13 relays UIDL command+argument (if any) to the host storage server unit 14.

Storage server unit 14 looks up the unique UID (for all if no args; or for specified arg) in the meta-data store 32. It then responds to the request with specified data.

Mediator 13 relays data.

IMAP Sessions. Storage server unit 14 contains User profile (mailboxes, access control lists and mbox permissions, index of meta-data) in the meta-data store 32. There is a per-user meta-data store 13 that contains information pertaining to what messages the User has processed (read/deleted/etc.).

User Issues LOGIN

Mediator 13 authenticates. As part of authentication, mediator 13 determines the particular one storage server units hosting the User's specified mailbox and establishes a connection to the hosting storage server unit 14. If authentication fails, the connections are torn down.

User Issues SELECT (Select a Mailbox)

Mediator 13 relays command to hosting storage server unit 14.

Storage server unit 14 opens the mailbox information from the meta-data store 32. If problems, returns error. Else returns OK.

Mediator 13 relays response to User.

User Issues FETCH (Selected Header Info; for Example, Headers of Last 50 Messages, etc.)

Mediator 13 relays header information.

Storage server unit 14 retrieves information from meta-data store 32 and responds.

Mediator 13 relays information to User.

User Issues FETCH (Selected Message Body; for Example, Body of Message 51)

Mediator 13 relays FETCH to host storage server unit 14.

Storage server unit 14 determines location of message body in content-data store 33 from a field in the meta-data store 32 for the message id and retrieves the message body from the content-data store 33 and includes body in response.

Mediator 13 relays the message body to the User.

User Issues STORE FLAGS/DELETED (Selected Message id)

Mediator 13 relays DELETE to host storage server unit 14.

Storage server unit 14 marks Delete field for message in meta-data store 32. Responds error or OK.

Mediator 13 relays response to User.

User Issues EXPUNGE (Issues Clean Signal to Remove Deleted Messages).

Mediator 13 relays EXPUNGE to host storage server unit 14.

Storage server unit 14 for each ULID in a UIDLIST indicates delete of a record for this UID in MESSAGEDB and indicates removal of this UID from UIDLIST in MAILBOXDB and sends Clean signal to initiate cleaning of this mailbox.

Messages are stored in a form that is native to SMTP. The storage server units do not need to do any computation or reformatting of a message from the format stored in the content-data store 33 in order to respond to a User request. This operation provides high throughput.

Also the meta-data store 32 is optimized for message-specific requests/actions. For example, a typical database may require several commands in order to mark a message as “deleted,” wherein in embodiments described, only one command is needed.

I. Databases used by POP/IMAP.

1. LISTDB: a list of all the valid mailbox names, access-control lists associated with each of them, and quota information (how many kbytes used, maximum usage allowed).

2. MAILBOXDB: a database associated with each mailbox. It contains, most importantly, the list of UIDs in this mailbox. Also, for each User who accesses the mailbox, a list of UIDs is stored which that User has seen (has read the associated message). Note: a UID is simply a unique identifier associated with a particular message in a mailbox.

3. MESSAGEDB: a database associated with each mailbox. For each UID associated with a message in a mailbox, it stores the size of that message as well as some flags (for example, the deleted flag) and the size of each message.

4. HEADERDB: a database associated with each mailbox. For each UID associated with a message in a mailbox, it stores a “Subject” field, a “From” field and a “Date” field.

All of these databases are accessed through a server known as “DB Server” which insures the integrity of the databases.

COPYRIGHT ® 1999 Mirapoint, Inc

II. POP
1. LOGIN (using any of several authentication methods)
If user is successfully authenticated, then

if mailbox has a “pop lock” then

print error message
return to authorization state

end if

place a “pop lock” on this mailbox
get list of UIDS for each message in the mailbox from MAILBOXDB
MSGNO = 1
For each uid in the list

set SIZE = retrieve from MESSAGEDB the size of this message
MESSAGES[MSGNO].uid = uid
MESSAGES[MSGNO].size = SIZE
MESSAGES[MSGNO].deleted = FALSE
LASTMESSAGE = MSGNO
MSGNO = MSGNO + 1

end for

else

print error message
return to authorization state

end if
2. STAT

set NMESSAGES = 0
set NBYTES = 0
I = 1
while (I < MSGNO)

if not MESSAGES[I].deleted then

NMESSAGES = NMESSAGES + 1
NBYTES = NBYTES + MESSAGES[I].size

end if
I = I + 1

end while
print value of NMESSAGES and NBYTES

3. LIST

if argument given to LIST

MSG = parse argument
if (MSG < 1 or MSG = MSGNO) then

print error

else

print value of MSG, MESSAGES[MSG].size

end if

else

set I = 1
while (I < MSGNO)

if not MESSAGES[I].deleted then

print value of I, MESSAGES[I].size

end if

I = I + 1

end while

end if

4. RETR

MSG = parse argument to RETR
if (MSG < 1 or MSG = MSGNO) then

print error

else

if MESSAGES[MSG].deleted then

print error

else

print contents of file associated with MSG

end if

end if

5. DELE

MSG = parse argument to RETR
if (MSG < 1 or MSG = MSGNO) then

print error

else

set MESSAGES[MSG].deleted = TRUE

end if

6. NOOP

print OK

7. RSET

I = 1
while (I < MSGNO)

set MESSAGES[I].deleted = FALSE
I = I + 1

end while

8. UIDL

if argument given to UIDL

MSG = parse argument
if (MSG < 1 or MSG = MSGNO) then

print error

else

print value of MSG, MESSAGES[MSG].uid

end if

else

I = 1
while (I < MSGNO)

if not MESSAGES[I].deleted then

print value of I, MESSAGES[I].uid

fi

I = I + 1
end while

end if

9. QUIT (Note that any modification to a database, MAILBOXDB or MESSAGEDB,

automatically causes a lock of the database and the lock remains until a COMMIT unlocks the
database)

if no messages have been deleted with DELE command

print OK
disconnect

else

set TXN = create transaction from DB server
I = 1
while (I < MSGNO)

if MESSAGES[I].deleted then

using TXN, send to DB server the following work items:
remove MESSAGES[I].uid from MAILBOXDB UID list
remove from MESSAGEDB record associated with uid

fi
I = I + 1

end while
send COMMIT to DB server for this TXN
if COMMIT fails

print error

else

send Clean signal to initiate cleaning of this mailbox

end if

end if
remove “pop lock” from mailbox

III. IMAP
1. LOGIN (using any of several authentication methods)

if (authentication is successful) then

set USER = authenticated user name

else

print error message
return to authorization state

fi

2. SELECT

MAILBOXNAME = parse argument to select
retrieve access-control list (ACL) from LISTDB for MAILBOXNAME.
if (mailbox doesn't exist or ACL doesn't permit USER to select) then

print error

else

acquire reference to MAILBOXDB from manager, manager opens

MAILBOX-NAME, if not already open, and places a reference on
the open queue

retrieve UIDLIST for MAILBOXNAME from MAILBOXDB.
print number of messages in mailbox (size of UIDLIST)

-- other information is looked up and printed (recent,

unseen, invalidity, etc.)--

end if

3. FETCH flags

FETCHUIDS = parse UIDS to fetch from mailbox
for each uid in FETCHUIDS

retrieve from MESSAGEDB flags for this UID in selected mailbox
print flags

end for

4. FETCH headers

FETCHUIDS = parse UIDS to fetch from mailbox
for each uid in FETCHUIDS

retrieve from HEADERDB headers for this UID in selected mailbox
print headers

end for

5. FETCH body

FETCHUIDS = parse UIDS to fetch from mailbox
for each uid in FETCHUIDS

open file associated with this UID in selected mailbox
print contents of file
close file

end for

6. STORE flags (deleted)

STOREUIDS = parse UIDS to fetch from mailbox
TXN = create transaction from DB server
for each uid in STOREUIDS

using TXN, set “deleted” flag for this UID in MESSAGEDB

end for
commit TXN
if (commit failed) then

print error

else

print OK

end if

7. EXPUNGE

if mailbox has a “pop lock” then

print error message
return to authorization state

end if
place a “pop lock” on this mailbox
create TXN
for each uid in UIDLIST

using TXN, indicate delete of record for this UID in MESSAGEDB
using TXN, indicate removal of this uid from UIDLIST in MAILBOXDB

end for
commit TXN
if (commit failed) then

print error

else

send Clean signal to initiate cleaning of this mailbox
print OK

end if
remove “pop lock” from this mailbox

8. CLEANER

while true,

| | |
|---|---|
| do | wait for Clean signal to clean MBOX, |
| | retrieve UIDLIST from MAILBOXDB for MBOX, |
| | For each file in MBOX's directory |

| | |
|---|---|
| do | if file not in UIDLIST |

delete file

endif

done

done

While the invention has been particularly shown and described with reference to preferred embodiments thereof it will be understood by those skilled in the art that various changes in form and details may be made therein without departing from the spirit and scope of the invention.

1. A message system for communication of messages over a network for users comprising:
means for receiving and delivering messages from and to the network, said messages including meta data and content data,
authentication means for authenticating users for ones of the messages from the network,
storage server means for storing the messages, said storage server means including,
a plurality of protocol server units for processing the messages according to protocols used for the messages over the network,
meta-data storage means for storing the meta data of messages,
content-data storage means for string the content data of messages,
manager means for common control of the meta-data storage means and the content-data storage means including,
common addressing means for common management of the addresses of messages at locations in the storage server means for messages of the plurality of protocol server units,
common access control means for controlling accesses to said locations in the storage server means by the plurality of protocol server units.

2. The message system of claim 1 wherein said
common access control means includes common locking means for common control of locks on said locations in the storage server means are for the plurality of protocol server units.

3. The message system of claim 2 wherein said locks are controlled by a lock algorithm accessed by each of said storage server means.

4. The message system of claim 4 wherein said lock algorithm terminates a lock whenever connection by said protocol server unit is terminated.

5. The message system of claim 1 wherein said protocol used for the messages over the network includes SMTP for message delivery to users.

6. The message system of claim 1 wherein said protocol used for the messages over the network includes POP for message access by users.

7. The message system of claim 1 wherein said protocol used for the messages over the network includes IMAP for message access by users.

8. A message system for communication of messages over a network for users comprising:
means for receiving and delivering messages from and to the network, said messages including meta data and content data,
authentication means for authenticating users for ones of the messages from the network,
storage server means for storing the messages, said storage server means including,
a plurality of protocol server units for processing the messages according to protocols used for the messages over the network,
meta-data storage means for storing the meta data of messages,
content-data storage means for string the content data of messages,
manager means for common control of the meta-data storage means and the content-data storage means including,
common addressing means for managing the address space for messages in the storage server means whereby messages are accessed at locations in the storage server means for the plurality of protocol server units under common control of the manager means,
common locking means for controlling locks on said locations whereby locks on said locations in the storage server means are for the plurality of protocol server units are under common control of the manager means.

9. A message system for communication of messages over a network for users comprising:
means for receiving and delivering messages from and to the network, said messages including meta data and content data,
authentication means for authenticating users for ones of the messages from the network,
storage server means for storing the messages, said storage server means including,
a plurality of protocol server units for processing the messages according to protocols used for the messages over the network,
meta-data storage means for storing the meta data of messages,
content-data storage means for string the content data of messages,
manager means for common control of the meta-data storage means and the content-data storage means including,
common addressing means for managing the address space for messages in the storage server means whereby messages are accessed at locations in the storage server means for the plurality of protocol server units under common control of the manager means,
common opening means for controlling the opening of said locations whereby said locations in the storage server means for the plurality of protocol server units are under common control of the manager means.
